(19) United States
(12) Patent Application Publication
(10) Pub. No.: US 2016/0269777 A1
(43) Pub. Date: Sep. 15, 2016

(54) METHOD AND DEVICE FOR ADJUSTING VIDEO PLAYBACK INTERFACE

(71) Applicant: LEMOBILE INFORMATION TECHNOLOGY (BEIJING) CO. LTD, Beijing (CN)

(72) Inventors: Shaopeng YU, Beijing (CN); Fan LIANG, Beijing (CN)

(21) Appl. No.: 15/033,086

(22) PCT Filed: Oct. 22, 2014
(86) PCT No.: PCT/CN2014/089193

§ 371 Date: Apr. 28, 2016

(30) Foreign Application Priority Data
Oct. 30, 2013 (CN) 201310530237.6

(51) Int. Cl. H04N 21/4402; H04N 21/4782; H04N 21/472

(52) U.S. Cl. CPC H04N 21/440272; H04N 21/472; H04N 21/4782

(57) ABSTRACT

Disclosed are a method and device for adjusting video playback interface, which are applicable to a smart television. The method comprises: acquiring a target network video on the basis of received actual playback address of the target network video; and stretching a display ratio of the acquired target network video on the basis of a predetermined screen aspect ratio of the smart television, to allow the target network video the be played back at the predetermined screen aspect ratio. With such a method, after the target network video is selected, the target network video can be automatically stretched and played back according to the ratio of the smart television screen during the playback of the target network video, so that the image fidelity can be ensured without the user's manual operation. The operation thereof is simple, and the user experience can be improved.

The present disclosure is a national stage of International Application No. PCT/CN2014/089193, filed Oct. 22, 2014, which claims priority from Chinese Patent Application No. 201310530237.6, titled “METHOD AND DEVICE FOR ADJUSTING VIDEO PLAYBACK INTERFACE”, filed on Oct. 30, 2013 in the Chinese Intellectual Property Office, the contents of which in its entirety are herein incorporated by reference.

### FIELD OF TECHNOLOGY

The present disclosure generally relates to the field of smart television, and more particularly, to a method and a device for adjusting video playback interface.

### BACKGROUND

Television is most common household electrical appliances in modern society. With the development of sciences and technologies, smart television having a full-open platform and provided with an operating system has emerged. A user can install and uninstall various applications by himself or herself while enjoying general television programs through the smart television, so that functions of the smart television can be continuously extended and updated to provide abundant and personalized experience for the user.

The smart television can realize webpage browsing and play back a video in a webpage.

However, when playing the videos on the network, the smart television in the prior art acquire video source via the webpage to directly play back at an original aspect ratio. As a result, the video can only be played back on the basis of the video window of the webpage. Since the sizes of the video windows are varied in websites and the screen sizes of the smart televisions (especially, the widescreen televisions) do not always match with the video windows of webpage, when the user is watching a network video on the smart television, the size of the video played back on the television screen is much less than the size of the television screen. Therefore, a black bar is formed between the television screen and the video, which may cause an undesirable watching effect to the user. In the case that the user would like to adjust the playback ratio of the video to properly display on the television screen, he/she is requested to select a suitable button to television screen aspect ratio from a plurality of scaling buttons set in the website. Thus, the video is played back after being stretched. Thus, operating process is complicated, lowering the user's experience.

### SUMMARY

In light of this, one of objectives of the present disclosure is to provide a method and device for adjusting video playback interface. When the video is selected by the user, a target network video can be automatically stretched to an aspect ratio most suitable to the smart television screen without the user's manual operation, and thus while the image fidelity is ensured, the user experience can be improved.

A method for adjusting video playback interface is proposed. The method is applicable to a smart television and includes:

acquiring a target network video on the basis of received actual playback address of the target network video; and

stretching a display ratio of the acquired target network video on the basis of a predetermined screen aspect ratio of the smart television, to allow the target network video the be played back at the predetermined screen aspect ratio.

According to above method, in an embodiment of the present disclosure, the size includes a width and a height, and the step of stretching a display ratio of the acquired target network video on the basis of a predetermined screen aspect ratio of the smart television includes:

judging whether the display ratio of the target network video is greater than the predetermined screen aspect ratio;

when the display ratio of the target network video is greater than the predetermined screen aspect ratio, stretching a width of the target network video to a screen width, stretching a height of the target network video in proportion to its width, and adding black watermark borders on both sides of the target network video in its height up to a screen height; and

when the display ratio of the target network video is not greater than the predetermined screen aspect ratio, stretching the height of the target network video to the screen height and stretching the width of the target network video to the screen width by a player.

According to above method, in an embodiment of the present disclosure, the predetermined screen aspect ratio of the smart television includes a 16:9 ratio of width to height.

According to above method, in an embodiment of the present disclosure, after acquiring the target network video on the basis of received actual playback address of the target network video and before stretching the display ratio of the acquired target network video on the basis of a predetermined screen aspect ratio of the smart television, the method further includes:

generating an inquiry message to inquire whether to stretch the playback and displaying it on the smart television screen;

when the message to determine the stretching playback is received, proceeding to the step of stretching the display size of the acquired target network video on the basis of the predetermined screen aspect ratio of the smart television;

otherwise, playing back at the display ratio of the target network video.

According to above method, in an embodiment of the present disclosure, after acquiring the target network video on the basis of received actual playback address of the target network video and before stretching the display ratio of the acquired target network video on the basis of a predetermined screen aspect ratio of the smart television, the method further includes:

judging whether the display ratio of the target network video falls into a predefined stretchable range, and if yes, proceeding to the step of stretching the display ratio of the acquired target network video on the basis of a predetermined screen aspect ratio of the smart television;

otherwise, playing back at the display ratio of the target network video,

wherein, the predefined stretchable range is a range in which the stretched target network video is not subjected to distortion, including: a 0.8˜1.2 ratio of the predetermined screen aspect ratio of the smart television to the target network video ratio.

A device for adjusting video playback interface is proposed. The device is applicable to a smart television and includes:

an acquiring module, configured to acquire a target network video on the basis of received actual playback address of the target network video; and

a stretching module, configured to stretch a display ratio of the acquired target network video on the basis of a predetermined screen aspect ratio of the smart television, to allow the target network video the be played back at the predetermined screen aspect ratio.

According to above device, in an embodiment of the present disclosure, the size includes a width and a height, and the stretching module includes: a judging module, a first stretching module and a second stretching module,

wherein, the judging module is configured to judge whether the display ratio of the target network video is greater than the predetermined screen aspect ratio, when the display ratio of the target network video is greater than the predetermined screen aspect ratio, trigger the first stretching module, and when the display ratio of the target network video is not greater than the predetermined screen aspect ratio, trigger the second stretching module;

the first stretching module is configured to stretch a width of the target network video to a screen width, stretch a height of the target network video in proportion to its width, and add black watermark borders on both sides of the target network video in its height up to a screen height; and

the second stretching module is configured to stretch the height of the target network video to the screen height, and stretch the width of the target network video to the screen width by the player.

According to above device, in an embodiment of the present disclosure, the device further includes an inquiry module and a first playback module,

wherein, the inquiry module is configured to generate an inquiry message to inquire whether to stretch the playback and display it on the smart television screen, wherein when a determination of the stretching playback is received, trigger the stretching module; otherwise trigger the first playback module; and

the first playback module is configured to play back at the display ratio of the target network video.

According to above device, in an embodiment of the present disclosure, the device further includes a judging module and a second playback module,

wherein, the judging module is configured to judge whether the display ratio of the target network video falls into a predefined stretchable range, and if yes, trigger the stretching module; otherwise, trigger the second playback module;

the second playback module is configured to play back at the display ratio of the target network video, and

wherein, the predefined stretchable range is a range in which the stretched target network video is not subjected to distortion, including: a 0.8˜1.2 ratio of the predetermined screen aspect ratio of the smart television to the target network video ratio.

A non-transitory computer readable recording medium having computer programs stored thereon that, when executed by one or more processors of an electronic apparatus, cause the electronic apparatus to perform:

acquiring a target network video on the basis of received actual playback address of the target network video; and

stretching a display ratio of the acquired target network video on the basis of a predetermined screen aspect ratio of the smart television, to allow the target network video the be played back at the predetermined screen aspect ratio.

There is further provided a smart television for adjusting video playback interface, characterized in that the smart television includes:

a memory having instructions stored thereon;

a processor configured to execute the instructions to for adjusting video playback interface, including:

acquiring a target network video on the basis of received actual playback address of the target network video; and

stretching a display ratio of the acquired target network video on the basis of a predetermined screen aspect ratio of the smart television, to allow the target network video the be played back at the predetermined screen aspect ratio.

There is provided a method for adjusting video playback interface in the present disclosure, which is applicable to a smart television and includes: acquiring a target network video on the basis of received actual playback address of the target network video; and stretching a display ratio of the acquired target network video on the basis of a predetermined screen aspect ratio of the smart television, to allow the target network video the be played back at the predetermined screen aspect ratio. With such a method, after the target network video is selected, the target network video can be automatically stretched and played back according to the ratio of the smart television screen during the playback of the target network video, so that the image fidelity can be ensured without the user's manual operation. The operation thereof is simple, and the user experience can be improved.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow chart of a method for adjusting video playback interface according to an embodiment of the present disclosure;

FIG. 2 is a flow chart of a method for adjusting video playback interface according to another embodiment of the present disclosure;

FIG. 3 is a flow chart of a method for adjusting video playback interface according to another embodiment of the present disclosure;

FIG. 4 is a flow chart of a method for adjusting video playback interface according to another embodiment of the present disclosure;

FIG. 5 is a schematic block diagram of a device for adjusting video playback interface according to an embodiment of the present disclosure;

FIG. 6 is a schematic block diagram of a device for adjusting video playback interface according to another embodiment of the present disclosure;

FIG. 7 is a schematic block diagram of a device for adjusting video playback interface according to another embodiment of the present disclosure;

FIG. 8 is a schematic block diagram of a device for adjusting video playback interface according to another embodiment of the present disclosure;

FIG. 9 is a flow chart of an application scenario of the method for adjusting video playback interface according to the present disclosure;

FIG. 10 is a flow chart of another application scenario of the method for adjusting video playback interface according to the present disclosure; and

FIG. 11 is a schematic diagram of a smart television screen in another application scenario of the method for adjusting video playback interface according to the present disclosure.

### DESCRIPTION OF THE EMBODIMENTS

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

The field of view from eyes of people has a width broader than its height. If the television does not have a screen in conformity with the visual window of eyes, surroundings on both sides of the television can be seen when people is watching the television such that concentration of people's thinking is disturbed and thus the experience of watching the television is deteriorated. The natural visual field of people has a ratio of 16:9. Therefore, in order to ensure a more preferable watching effect of an audience, most of commercially available LCD televisions at present employ a widescreen aspect ratio such as 16:9. In an embodiment of the present disclosure, the screen aspect ratio of the smart television also employs 16:9.

When a user requests to play back a target network video, a browser may acquire a video tag in a webpage where the target network video is located. The video tag is a dedicated tag of the target network video. The video tag may be parsed to acquire a display size of the target network video in the page and an actual playback address of the video. Detailed processes thereof are as follows:

(1) acquiring a tag a of the webpage, and acquiring a URL of the target network video according to the tag a;

(2) according to the URL, loading a corresponding HTML5 video page which includes a HTML5 video tag; and

(3) invoking a JavaScript function to parse the HTML5 video tag to acquire a display size of the target network video in the page and the actual playback address of the video, and acquiring a display ratio of the target network video according to the display size in the page.

The method for adjusting video playback interface provided in the embodiment of the present disclosure is a method implemented in a player of the smart television.

The player involved in the present disclosure may be software capable of playing video or audio files stored in the form of digital signal. The software installed on the smart television can include a variety of players, such as media player and RealPlayer.

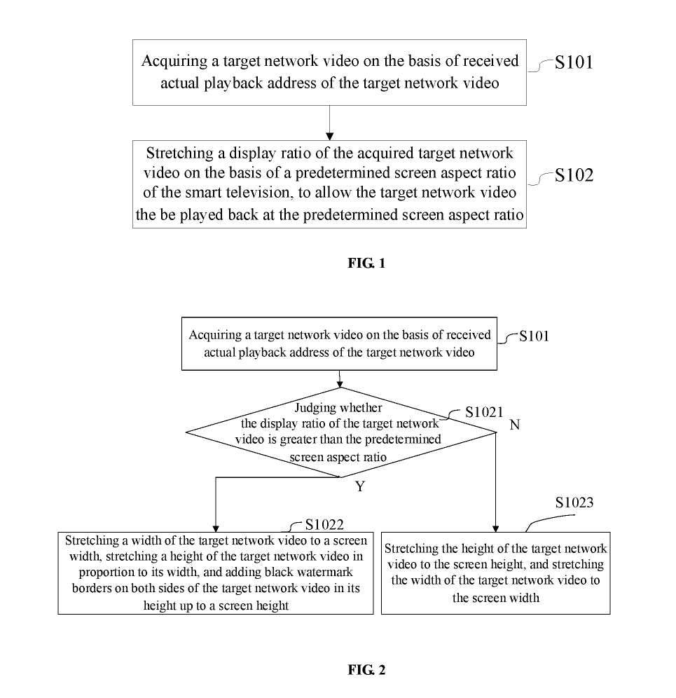

With reference to FIG. 1, the flow chart of the method for adjusting video playback interface provided in an embodiment of the present disclosure, includes steps as follows.

Step S101: acquiring a target network video on the basis of received actual playback address of the target network video.

After receiving the actual playback address of the target network video, the player can acquire the target network video according to the actual playback address.

Step S102: stretching a display ratio of the acquired target network video on the basis of a predetermined screen aspect ratio of the smart television, to allow the target network video the be played back at the predetermined screen aspect ratio.

The screen aspect ratio of the smart television can be stored in advance. It may be known that the target network video is required to be played back when the actual playback address of the target network video is received. At this point, the screen aspect ratio can be acquired from the memory storage.

The player can stretch the target network video on the basis of the 16:9 screen aspect ratio of the smart television such that the target network video follows the predetermined screen aspect ratio during playback to ensure a more advantageous watching effect for an audience.

In particular, the predetermined screen aspect ratio can be used to set the playback ratio of the player. When playing back the acquired target network video, the player may play back the target network information at the playback ration.

In conclusion, the method for adjusting video playback interface provided in this embodiment may include: acquiring a target network video on the basis of received actual playback address of the target network video; and stretching a display ratio of the acquired target network video on the basis of a predetermined screen aspect ratio of the smart television, to allow the target network video the be played back at the predetermined screen aspect ratio. With such a method, the target network video can be automatically stretched according to the predetermined aspect ratio of the smart television screen, such that the playback size of the video can reach the natural field of vision which is the best to people without the user's manual operation, thus improving the user experience.

With reference to FIG. 2, it shows the flow chart of the method for adjusting video playback interface provided in another embodiment of the present disclosure. In the flow chart as shown in FIG. 1, Step S102 may include:

step S1021: judging whether the display ratio of the target network video is greater than the predetermined screen aspect ratio, and if yes, proceeding to Step S1022; otherwise, proceeding to Step S1023.

The predetermined screen aspect ratio may be 16:9.

The relation between the display ratio of the target network video and the predetermined screen aspect ratio is judged. When the display ratio of the target network video is not greater than the predetermined screen aspect ratio of 16:9, the target network video can be stretched to a 16:9 display effect to fill the smart television screen. If a full-screen state can be reached, then proceed to Step S1023; or, if a full-screen state cannot be reached, then proceed to Step S1022.

Step S1022: stretching a width of the target network video to a screen width, stretching a height of the target network video in proportion to its width, and adding black watermark borders on both sides of the target network video in its height up to a screen height.

The ratio refers to width:height.

When the display ratio of the target network video is greater than the predetermined screen aspect ratio of 16:9, the process of stretching the target network video to the predetermined screen aspect ratio may include:

stretching the width of the target network video to the screen width, such that the playback width of target network video reaches the width of the full-screen; and

stretching the height of the target network video in proportion to its width, so that the target network video can be played back without distortion. Since the height of the target network video does not reach the height of full-screen due to proportional stretch, the black watermark borders are added on both sides of the target network video in its height up to the screen height.

Step S1023: stretching the height of the target network video to the screen height, and stretching the width of the target network video to the screen width.

When the display ratio of the target network video is not greater than the predetermined screen aspect ratio of 16:9, the target network video can be stretched to the predetermined screen aspect ratio. It is directly stretched to the screen size (width and height) both in width and height direction. In other words, the width of the target network video is stretched to the screen width, while the height of the target network video is stretched to the screen height, such that the target network video can fill the screen during playback.

In conclusion, the method for adjusting video playback interface provided in this embodiment may further include: judging whether the display ratio of the target network video is greater than the predetermined screen aspect ratio; when the display ratio of the target network video is greater than the predetermined screen aspect ratio, the player stretching a width of the target network video to a screen width, stretching a height of the target network video in proportion to its width, and adding black watermark borders on both sides of the target network video in its height up to a screen height; when the display ratio of the target network video is not greater than the predetermined screen aspect ratio, the player stretching the height of the target network video to the screen height, and stretching the width of the target network video to the screen width. With such a method, the target network video can be stretched automatically in different manners according to the size relation between the predetermined screen aspect ratio of the smart television screen and the display ratio of the target network video, such that the video can be played back as full screen as possible to make playback image satisfy peoples' watching habit.

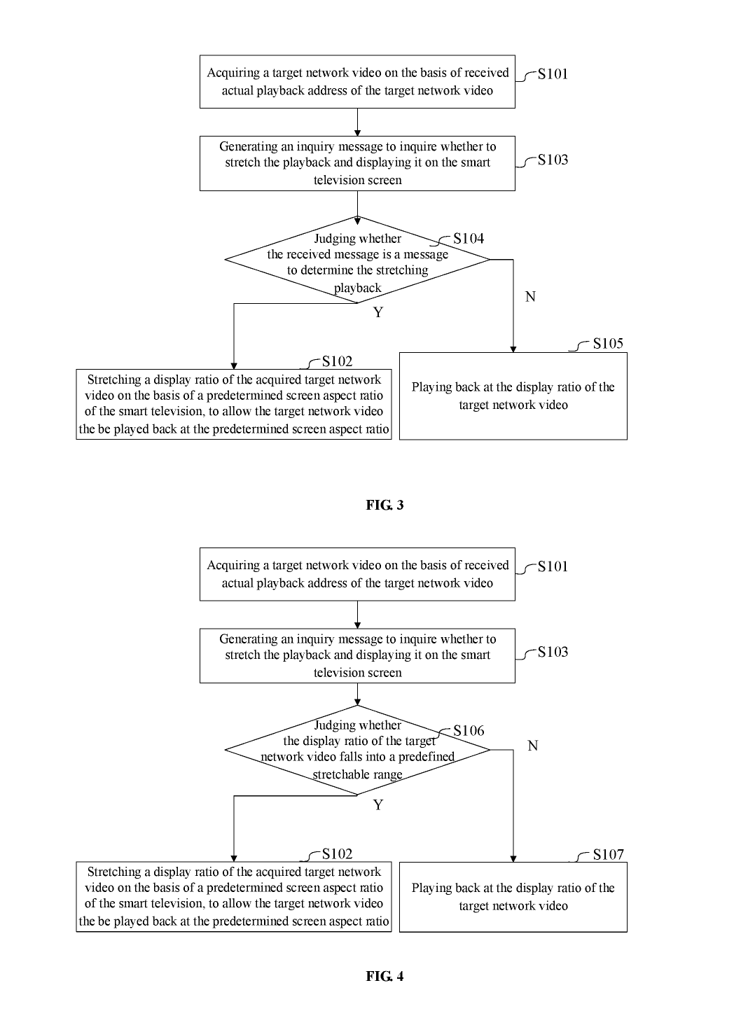

With reference to FIG. 3, it shows the flow chart of the method for adjusting video playback interface provided in another embodiment of the present disclosure. In the flow chart as shown in FIG. 1, following steps may be further included between Step S101 and Step S102:

step S103: generating an inquiry message to inquire whether to stretch the playback and displaying it on the smart television screen.

The user may determine whether to stretch the playback according to his/her own preference or habits. Before stretching the target network video, the player may generate the inquiry message to inquire whether to stretch the playback and display the inquiry message on the smart television screen to provide the user with option to stretch or not. The user may choose to stretch playback or not to stretch playback by himself or herself via a controller (such as a remote control). A feedback message can be generated and sent to the smart television.

Step S104: judging whether the received message is a message to determine the stretching playback, and if yes, proceeding to Step S102; otherwise, proceeding to Step S105.

After receiving the feedback message, the player may judge whether the message is a message to determine the stretching playback. If yes, proceed to Step S102, which includes: stretching the display size of the target network video in the page on the basis of the predetermined screen aspect ratio of the smart television, such that the target network video can be played back as full screen as possible on the smart television.

Step S105: playing back at the display ratio of the target network video.

If the message acquired by the player is not a message to determine the stretching playback, then the stretching playback would be negated. In this regard, the player will no longer stretch the target network video, but play back the target network video at a size as it is displayed in the page.

In conclusion, the method for adjusting video playback interface provided in this embodiment may further include: generating an inquiry message to inquire whether to stretch the playback and displaying it on the smart television screen; when a message to determine the stretching playback is received, proceeding to the step of stretching the display ratio of the acquired target network video on the basis of the predetermined screen aspect ratio of the smart television; otherwise, playing back at the display ratio of the target network video. Before the target network video is stretched, an inquiry message to inquire whether to stretch can be proposed. The user may determine whether to stretch on the basis of his or her own use habits, thereby improving user's participation and providing better user experience.

With reference to FIG. 4, it shows the flow chart of the method for adjusting video playback interface provided in another embodiment of the present disclosure. In the flow chart as shown in FIG. 1, following steps may be further included between Step S101 and Step S102:

Step S106: judging whether the display ratio of the target network video falls into a predefined stretchable range, and if yes, proceeding to Step S102; otherwise, proceeding to Step S107.

Since, in the process of stretching, there is a difference between the target network video ratio and the predetermined screen aspect ratio of the smart television, the stretched target network video may be subjected to image distortion when being displayed on the screen. Once the image distortion occurs, it may interfere with user's watching effect and deteriorate user experience. Therefore, when the target network video ratio falls into the predefined stretchable range, i.e., it is stretched without distortion, proceed to Step S102 to stretch the target network video; otherwise, proceed to Step S107 not to stretch it.

The predefined stretchable range is a range in which the stretched target network video is not subjected to distortion, including: a 0.8˜1.2 ratio of the predetermined screen aspect ratio of the smart television to the target network video ratio.

Step S107: playing back at the display ratio of the target network video.

When the target network video ratio does not fall into the predefined stretchable range, i.e., it is stretched with distortion, the target network video will not be stretched rather than being played back at a ratio as displayed in the page.

In conclusion, the method for adjusting video playback interface provided in this embodiment may further include: judging whether the display ratio of the target network video falls into a predefined stretchable range, and if yes, stretching the display ratio of the acquired target network video on the basis of the predetermined screen aspect ratio of the smart television; otherwise playing back at the display ratio of the target network video. The target network video will be stretched when it satisfies the stretching requirement; otherwise not stretched, thereby ensuring that the stretched video images are played back without distortion so as to provide higher user experience.

The present disclosure also provides a computer readable recording medium in which a program configured to execute above methods is recorded.

The computer readable recording medium may comprise any mechanism for storing or transmitting information in a readable form of a computing device (e.g., a computer). For example, the machine readable medium includes Read Only Memory (ROM), Random Access Memory (RAM), magnetic disk storage medium, optical storage medium, flash memory medium, and propagation signals (e.g., carrier wave, infrared signals, digital signals, etc.) in the forms of electrics, optics, acoustics or any other forms.

Correspondingly to the embodiments of the method for adjusting video playback interface, there is also provided the embodiments of the device for adjusting video playback interface in the specification of the present disclosure.

With reference to FIG. 5, it shows a schematic block diagram of a device for adjusting video playback interface according to an embodiment of the present disclosure. The device may include: an acquiring module 101 and a stretching module 102.

Herein, the acquiring module 101 is configured to acquire a target network video on the basis of received actual playback address of the target network video;

After receiving the actual playback address of the target network video, the acquiring module 101 in a player can acquire the target network video according to the actual playback address.

Herein, the stretching module 102 is configured to stretch a display ratio of the acquired target network video on the basis of a predetermined screen aspect ratio of the smart television, to allow the target network video the be played back at the predetermined screen aspect ratio.

The screen aspect ratio of the smart television can be stored in advance. It may be known that the target network video is required to be played back when the player receives the actual playback address of the target network video. At this point, the screen aspect ratio can be acquired from the memory storage.

The stretching module 102 can stretch the target network video on the basis of the 16:9 screen aspect ratio of the smart television such that the target network video follows the predetermined screen aspect ratio during playback to ensure a more advantageous watching effect for an audience.

In particular, the predetermined screen aspect ratio can be used to set the playback ratio of the player. When playing back the acquired target network video, the player may play back the target network information at the playback ration.

In conclusion, the device for adjusting video playback interface provided in this embodiment may include: an acquiring module, configured to acquire a target network video on the basis of received actual playback address of the target network video; and a stretching module, configured to stretch a display ratio of the acquired target network video on the basis of a predetermined screen aspect ratio of the smart television, to allow the target network video the be played back at the predetermined screen aspect ratio. With such a device, the target network video can be automatically stretched according to the predetermined aspect ratio of the smart television screen, such that the playback size of the video can reach the natural field of vision which is the best to people without the user's manual operation, thus improving the user experience.

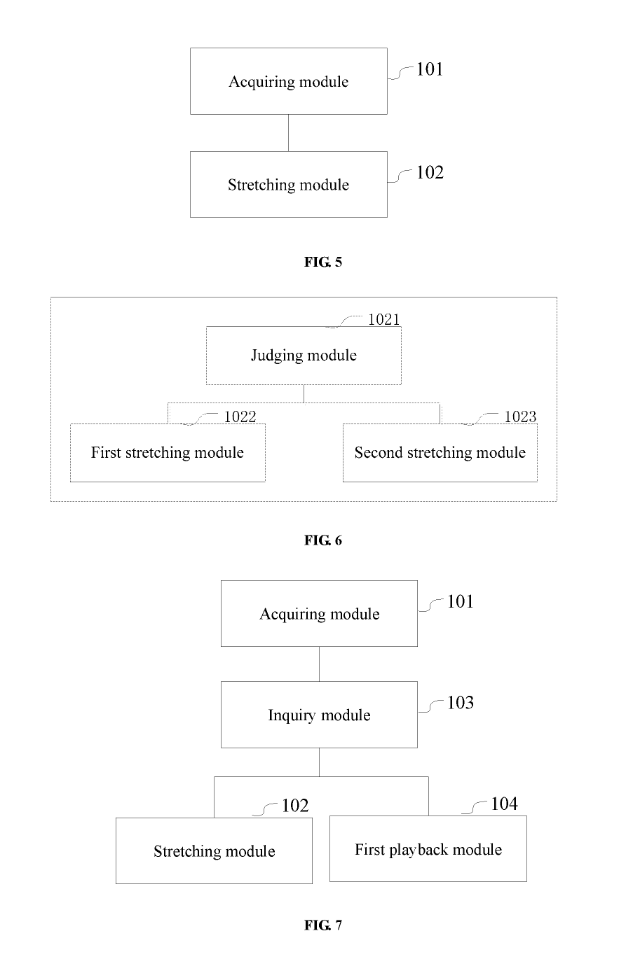

With reference to FIG. 6, it shows the schematic block diagram of the device for adjusting video playback interface provided in another embodiment of the present disclosure. In the structure as shown in FIG. 5, the stretching module 102 may include: a judging module 1021, a first stretching module 1022 and a second stretching module 1023.

Herein, the judging module 1021 is configured to judge whether the display ratio of the target network video is greater than the predetermined screen aspect ratio, when the display ratio of the target network video is greater than the predetermined screen aspect ratio, trigger the first stretching module 1022, and when the display ratio of the target network video is not greater than the predetermined screen aspect ratio, trigger the second stretching module 1023.

The predetermined screen aspect ratio may be 16:9.

The judging module 1021 can judge the relation between the display ratio of the target network video and the predetermined screen aspect ratio, and when the display ratio of the target network video is not greater than the predetermined screen aspect ratio of 16:9, trigger the second stretching module 1023 to stretch the target network video to a 16:9 display effect and fill the smart television screen to reach a full-screen state; otherwise trigger the first stretching module 1022 if a full-screen state cannot be reached.

The first stretching module 1022 is configured to stretch a width of the target network video to a screen width, stretch a height of the target network video in proportion to its width, and add black watermark borders on both sides of the target network video in its height up to a screen height.

The ratio refers to width:height.

When the display ratio of the target network video is greater than the predetermined screen aspect ratio of 16:9, the process in which the first stretching module 1022 stretches the target network video to the predetermined screen aspect ratio may include:

stretching the width of the target network video to the screen width, such that the playback width of target network video reaches the width of the full-screen; and

stretching the height of the target network video in proportion to its width, so that the target network video can be played back without distortion. Since the height of the target network video does not reach the height of full-screen due to proportional stretch, the black watermark borders are added on both sides of the target network video in its height up to the screen height.

The second stretching module 1023 is configured to stretch the height of the target network video to the screen height, and stretch the width of the target network video to the screen width by the player.

When the display ratio of the target network video is not greater than the predetermined screen aspect ratio of 16:9, the target network video can be stretched to the predetermined screen aspect ratio by the second stretching module 1023. It is directly stretched to the screen size (width and height) both in width and height direction. In other words, the width of the target network video is stretched to the screen width, while the height of the target network video is stretched to the screen height, such that the target network video can fill the screen during playback.

In conclusion, the device for adjusting video playback interface is provided in this embodiment, the stretching module including: the judging module, the first stretching module and the second stretching module; herein, the judging module is configured to judge whether the display ratio of the target network video is greater than the predetermined screen aspect ratio, when the display ratio of the target network video is greater than the predetermined screen aspect ratio, to trigger the first stretching module, and when the display ratio of the target network video is not greater than the predetermined screen aspect ratio, to trigger the second stretching module; the first stretching module is configured to stretch a width of the target network video to a screen width, stretch a height of the target network video in proportion to its width, and add black watermark borders on both sides of the target network video in its height up to a screen height; the second stretching module is configured to stretch the height of the target network video to the screen height, and the player can stretch the width of the target network video to the screen width. With such a device, the target network video can be stretched automatically in different manners according to the size relation between the predetermined screen aspect ratio of the smart television screen and the display ratio of the target network video, such that the video can be played back as full screen as possible to make playback image satisfy peoples' watching habit.

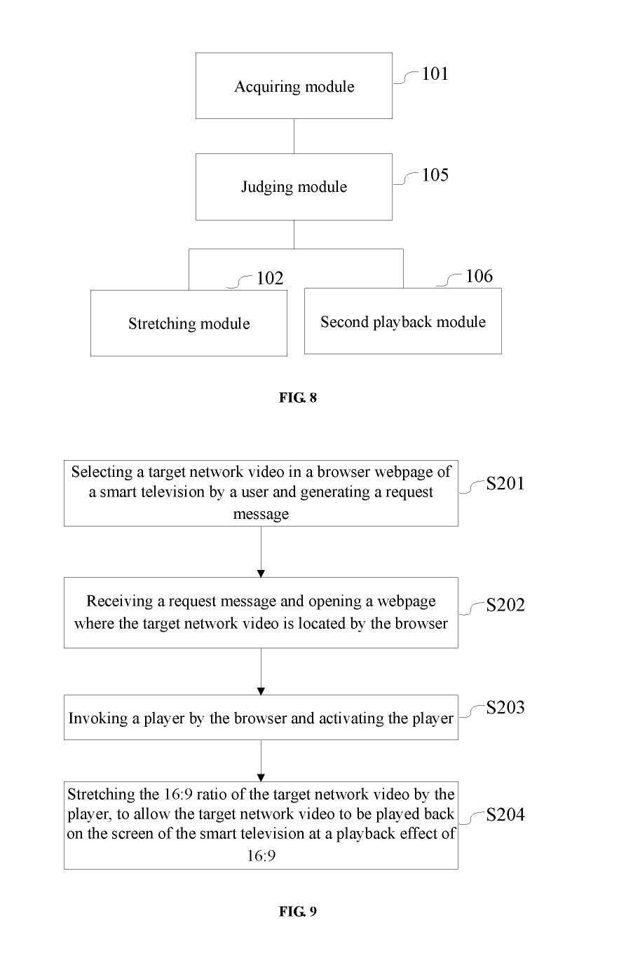

With reference to FIG. 7, it shows the schematic block diagram of the device for adjusting video playback interface provided in another embodiment of the present disclosure. In the structure as shown in FIG. 5, the device may further include: an inquiry module 103 and a first playback module 104.

Herein, the inquiry module 103 is configured to generate an inquiry message to inquire whether to stretch the playback and display it on the smart television screen, wherein when a determination of the stretching playback is received, trigger the stretching module 102; otherwise trigger the first playback module 104;

The user may determine whether to stretch the playback according to his/her own preference or habits. Before stretching the target network video, the inquiry module 103 may generate the inquiry message to inquire whether to stretch the playback and display the inquiry message on the smart television to provide the user with option to stretch or not. The user may choose to stretch playback or not to stretch playback by himself or herself via a controller (such as a remote control). A feedback message can be generated and sent to the smart television.

After receiving the feedback message, the inquiry module 103 may judge whether the message is a message to determine to the stretching playback. If yes, the stretching module 102 can be triggered to stretch the display size of the target network video in the page on the basis of the predetermined screen aspect ratio of the smart television, such that the target network video can be played back as full screen as possible on the smart television, otherwise the first playback module 104 can be triggered.

Herein, the first playback module 104 is configured to play back at the display ratio of the target network video.

If the message acquired by the player is not a message to determine the stretching playback, then the stretching playback will be negated. In this regard, the player will no longer stretch the target network video and the first playback module 104 will play back the target network video at a size as it is displayed in the page.

In conclusion, the device for adjusting video playback interface provided in this embodiment may further include: the inquiry module, configured to generate an inquiry message to inquire whether to stretch the playback and display it on the smart television screen, wherein when a determination of the stretching playback is received, it can trigger the stretching module; otherwise trigger the first playback module; and the first playback module, configured to play back at the display ratio of the target network video. Before the target network video is stretched, an inquiry message to inquire whether to stretch can be proposed. The user may determine whether to stretch on the basis of his or her own use habits, thereby improving user's participation and providing better user experience.

With reference to FIG. 8, it shows the schematic block diagram of the device for adjusting video playback interface. In the flow chart as shown in FIG. 5, the device may further include: a judging module 105 and a second playback module 106.

Herein, the judging module 105 is configured to judge whether the display ratio of the target network video falls into a predefined stretchable range, and if yes, trigger the stretching module 102; otherwise, trigger the second playback module 106.

Since, in the process of stretching, there is a difference between the target network video ratio and the predetermined screen aspect ratio of the smart television, the stretched target network video may be subjected to image distortion when being displayed on the screen. Once the image distortion occurs, it may interfere with user's watching effect and deteriorate user experience. Therefore, the judging module 105 can judge whether the display ratio of the target network video falls into the predefined stretchable range. If the display ratio of the target network video falls into the predefined stretchable range, i.e., it is stretched without distortion, then the stretching module 102 is triggered to stretch the target network video; otherwise, the second playback module 106 is triggered not to stretch it.

The predefined stretchable range is a range in which the stretched target network video is not subjected to distortion, including: a 0.8˜1.2 ratio of the predetermined screen aspect ratio of the smart television to the target network video ratio.

Herein, the second playback module 106 is configured to play back at the display ratio of the target network video.

When the judging module 105 judges that the target network video does not fall into the predefined stretchable range, i.e., it is stretched with distortion, the target network video will not be stretched and the second playback module 106 will play back the target network video at a ratio as displayed in the page.

In conclusion, the device for adjusting video playback interface provided in another embodiment of the present disclosure may further include: the judging module, configured to judge whether the display ratio of the target network video falls into a predefined stretchable range, and if yes, trigger the stretching module; otherwise, trigger the second playback module; and the second playback module, configured to play back at the display ratio of the target network video. The target network video will be stretched when it satisfies the stretching requirement; otherwise not stretched, thereby ensuring that the stretched video images are played back without distortion so as to provide higher user experience.

The present disclosure also provides specific application scenarios of the method for adjusting video playback interface in practice.

A specific flow chart of an application scenario is shown in FIG. 9.

Step S201: selecting a target network video in a browser webpage of a smart television by a user and generating a request message.

The user may select a desirable target network video to watch in the webpage displayed on the smart television via a controller (such as, a remote control).

Step S202: receiving a request message and opening a webpage where the target network video is located by the browser.

After the browser receives the request message, the browser may be opened to acquire a video tag of the webpage, and the video tag may be parsed to acquire a display size of the target network video in the page and an actual playback address of the video. A ratio of the target network video can be acquired on the basis of the display size of the target network video in the page. In this application scenario, the ratio is 16:9.

Step S203: invoking a player by the browser and activating the player.

The browser may send a call request for invoking the player in order to play back the target network video on the smart television by the player.

The player is activated, and then the target network video is available according to the actual playback address.

Step S204: stretching the 16:9 ratio of the target network video by the player, to allow the target network video to be played back on the screen of the smart television at a playback effect of 16:9.

After acquiring the target network video, the player can stretch the video. The height of the target network video is stretched to the height of the smart television screen and the width thereof is stretched to the width of the smart television, such that the video can be played back on the screen of the smart television at the effect of 16:9 (i.e., full-screen).

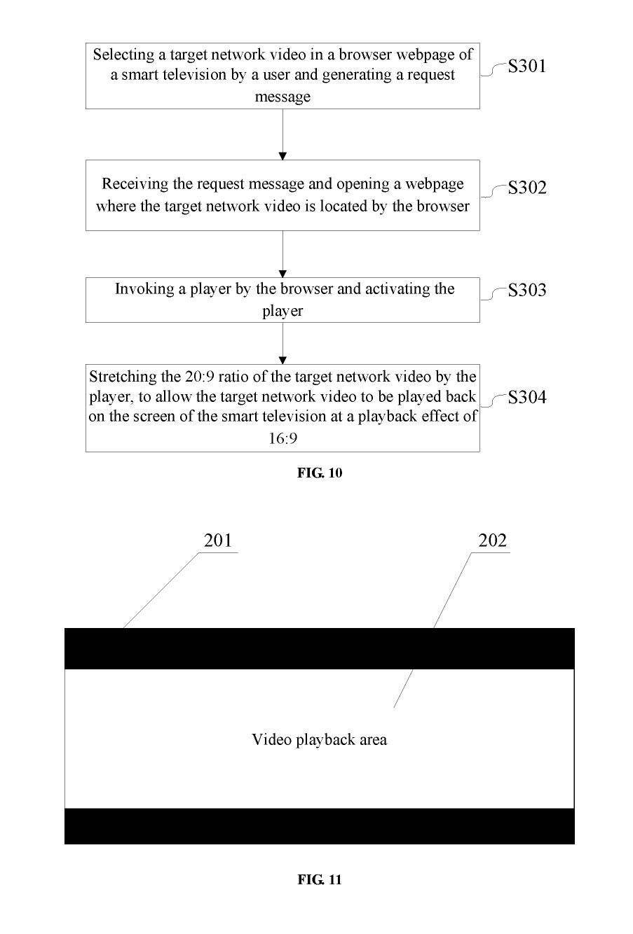

A specific flow chart of another application scenario is shown in FIG. 10.

Step S301: selecting a target network video in a browser webpage of a smart television by a user and generating a request message.

The user may select a desirable target network video to watch in the webpage displayed on the smart television via a controller (such as, a remote control).

Step S302: receiving the request message and opening a webpage where the target network video is located by the browser.

After the browser receives the request message, the browser may be opened to acquire a video tag of the webpage, and the video tag may be parsed to acquire a display size of the target network video in the page and an actual playback address of the video. A ratio of the target network video can be acquired on the basis of the display size of the target network video in the page. In this application scenario, the ratio is 20:9.

Step S303: invoking a player by the browser and activating the player.

The browser may send a call request for invoking the player in order to play back the target network video on the smart television by the player.

The player is activated, and then the target network video is available according to the actual playback address.

Step S304: stretching the 20:9 ratio of the target network video by the player, to allow the target network video to be played back on the screen of the smart television at a playback effect of 16:9.

After acquiring the target network video, the player can stretch the video. The width of the target network video is stretched to the width of the smart television screen, the height is stretched in proportion to its width, and black watermark borders are added on both sides of the target network video in its height up to the screen height.

FIG. 11 shows a schematic diagram of the smart television screen 201. While a video playback area 202 does not fill the smart television screen 201, the black watermark borders are added to unfilled areas on both sides of the target network video in its height.

The method and device for adjusting video playback interface according to the present disclosure have been described in detail. Herein the principles and implementations of the present disclosure are illustrated by way of specific examples. The embodiments described above are only intended to help understand the method and main concept of the present disclosure. Meanwhile, for an ordinary skilled person in the art, variations could be made to the specific implementations and their application scope in accordance with concepts of the present disclosure. In summary, the contents of the specification should not be construed as limiting of the present disclosure.

1. A method for adjusting video playback interface, characterized in that the method is applicable to a smart television and comprises:
acquiring a target network video on the basis of received actual playback address of the target network video; and
stretching a display ratio of the acquired target network video on the basis of a predetermined screen aspect ratio of the smart television, to allow the target network video the be played back at the predetermined screen aspect ratio.

2. The method according to claim 1, characterized in that the size comprises a width and a height, and the step of stretching a display ratio of the acquired target network video on the basis of a predetermined screen aspect ratio of the smart television comprises:
judging whether the display ratio of the target network video is greater than the predetermined screen aspect ratio;
when the display ratio of the target network video is greater than the predetermined screen aspect ratio, stretching a width of the target network video to a screen width, stretching a height of the target network video in proportion to its width, and adding black watermark borders on both sides of the target network video in its height up to a screen height; and
when the display ratio of the target network video is not greater than the predetermined screen aspect ratio, stretching the height of the target network video to the screen height and stretching the width of the target network video to the screen width by a player.

3. The method according to claim 1, characterized in that the predetermined screen aspect ratio of the smart television comprises a 16:9 ratio of width to height.

4. The method according to claim 1, characterized in that after acquiring the target network video on the basis of received actual playback address of the target network video and before stretching the display ratio of the acquired target network video on the basis of a predetermined screen aspect ratio of the smart television, the method further comprises:
generating an inquiry message to inquire whether to stretch the playback and displaying it on the smart television screen;
when the message to determine the stretching playback is received, proceeding to the step of stretching the display size of the acquired target network video on the basis of the predetermined screen aspect ratio of the smart television;
otherwise, playing back at the display ratio of the target network video.

5. The method according to claim 1, characterized in that after acquiring the target network video on the basis of received actual playback address of the target network video and before stretching the display ratio of the acquired target network video on the basis of a predetermined screen aspect ratio of the smart television, the method further comprises:
judging whether the display ratio of the target network video falls into a predefined stretchable range, and if yes, proceeding to the step of stretching the display ratio of the acquired target network video on the basis of a predetermined screen aspect ratio of the smart television;
otherwise, playing back at the display ratio of the target network video,
wherein, the predefined stretchable range is a range in which the stretched target network video is not subjected to distortion, comprising: a 0.8˜1.2 ratio of the predetermined screen aspect ratio of the smart television to the target network video ratio.

6. A smart television for adjusting video playback interface, characterized in that the smart television comprises:
a memory having instructions stored thereon;
a processor configured to execute the instructions to for adjusting video playback interface, comprising:
acquiring a target network video on the basis of received actual playback address of the target network video; and
stretching a display ratio of the acquired target network video on the basis of a predetermined screen aspect ratio of the smart television, to allow the target network video the be played back at the predetermined screen aspect ratio.

7. The smart television according to claim 6, characterized in that the size comprises a width and a height, the processor is further configured to perform:
judging whether the display ratio of the target network video is greater than the predetermined screen aspect ratio, when the display ratio of the target network video is greater than the predetermined screen aspect ratio, trigger the first stretching module, and when the display ratio of the target network video is not greater than the predetermined screen aspect ratio, trigger the second stretching module;
stretching a width of the target network video to a screen width, stretch a height of the target network video in proportion to its width, and add black watermark borders on both sides of the target network video in its height up to a screen height; and
stretching the height of the target network video to the screen height, and stretch the width of the target network video to the screen width by the player.

8. The smart television according to claim 6, characterized in that, the processor is further configured to perform:
generating an inquiry message to inquire whether to stretch the playback and display it on the smart television screen, wherein when a determination of the stretching playback is received, stretching a display ratio of the acquired target network video on the basis of a predetermined screen aspect ratio of the smart television, to allow the target network video the be played back at the predetermined screen aspect ratio; otherwise playing back at the display ratio of the target network video.

9. The smart television according to claim 6, characterized in that, the processor is further configured to:
judging whether the display ratio of the target network video falls into a predefined stretchable range, and if yes, stretching a display ratio of the acquired target network video on the basis of a predetermined screen aspect ratio of the smart television, to allow the target network video the be played back at the predetermined screen aspect ratio; otherwise,
playing back at the display ratio of the target network video, and
wherein, the predefined stretchable range is a range in which the stretched target network video is not subjected to distortion, comprising: a 0.8˜1.2 ratio of the predetermined screen aspect ratio of the smart television to the target network video ratio.

10. A non-transitory computer readable recording medium having computer programs stored thereon that, when executed by one or more processors of an electronic apparatus, cause the electronic apparatus to perform:
acquiring a target network video on the basis of received actual playback address of the target network video; and
stretching a display ratio of the acquired target network video on the basis of a predetermined screen aspect ratio of the smart television, to allow the target network video the be played back at the predetermined screen aspect ratio.
